(19) United States
(12) Patent Application Publication
(10) Pub. No.: US 2003/0059346 A1
(43) Pub. Date: Mar. 27, 2003

(54) Method and apparatus for environmental phosphate/nitrate pollution removal using a selectively permeable molecularly imprinted polymer membrane

(76) Inventor: George M. Murray, Columbia, MD (US)

Correspondence Address: Francis A. Cooch, Office of Patent Counsel, THE JOHNS HOPKINS UNIVERSITY, Applied Physics Laboratory, 11100 Johns Hopkins Road, Laurel, MD, 20723-6099, US

(21) Appl. No.: 10/229,884

(22) Filed: Aug. 27, 2002

Related U.S. Application Data
(60) Provisional application No. 60/315,781, filed on Aug. 28, 2001.

(51) Int. Cl. G01N 1/18

(52) U.S. Cl. 422/100; 436/110; 436/178

(57) ABSTRACT

The invention comprises a selectively permeable molecularly imprinted polymer membrane for the removal of phosphate/nitrate anions from solutions. The polymeric membrane will be synthesized with ingredients for both selective binding and improved permeability. The selective binding site will be prepared by using ferric ion imprinting. Permeability is improved by using a polyester that associates with the metal ions; the polyester will be removed from the membrane by the same acid treatment used to remove the ferric ion. The polyester creates channels directing the ion migration to the imprinted sites, thus, increasing flux but maintaining selectivity.

### CROSS-REFERENCE TO RELATED APPLICATIONS

This application claims priority to U.S. Provisional application serial No. 60/315,781, filed Aug. 28, 2001.

### DETAILED DESCRIPTION

Molecular imprinting is a process for making selective recognition sites in synthetic polymers. The process employs a target molecule as the template. The template is surrounded by molecular compliments that possess polymerizable functionalities. The template complex is typically co-polymerized with a matrix monomer and a cross-linking monomer in the presence of a suitable solvent. The cross linking monomers add rigidity to the finished polymer and the solvent provides site accessibility. Removal of the template molecules leaves behind cavities that exhibit enhanced affinity for rebinding the target molecule. Previously, we used the molecular imprinting technique to prepare a selectively permeable membrane for the removal of uranyl ion from solutions. See A. Kimaro, L. A. Kelly, and G. M. Murray, Chem. Commun., 2001, 1282-1293, which is hereby incorporated herein by reference in its entirety. By changing the formula to produce a selective binding site for phosphate anions we can make membranes selective to this nutrient species.

The polymeric membranes will be synthesized with ingredients for both selective binding and improved permeability. The selective binding site will prepared by using ferric ion imprinting. Permeability will be addressed using a polyester that associates with the metal ions. The length of the alkyl chain in the diol that was used to make the polyester controlled the spacing of association sites. The polyester will be removed from the membrane by the same acid treatment used to remove the ferric ion. Removal of the polyester from a uranyl templated membrane was detected by GC-MS of the membrane acid wash solutions. The polyester is intended to create channels, directing ion migration to the imprinted sites, thus increasing flux but maintaining selectivity. The addition of polyester to the formula had two significant results. The amount of swelling of the membrane in aqueous solutions was dramatically increased and in the absence of the polyester there was no detectable migration of ions for a previous uranyl imprinted membrane.

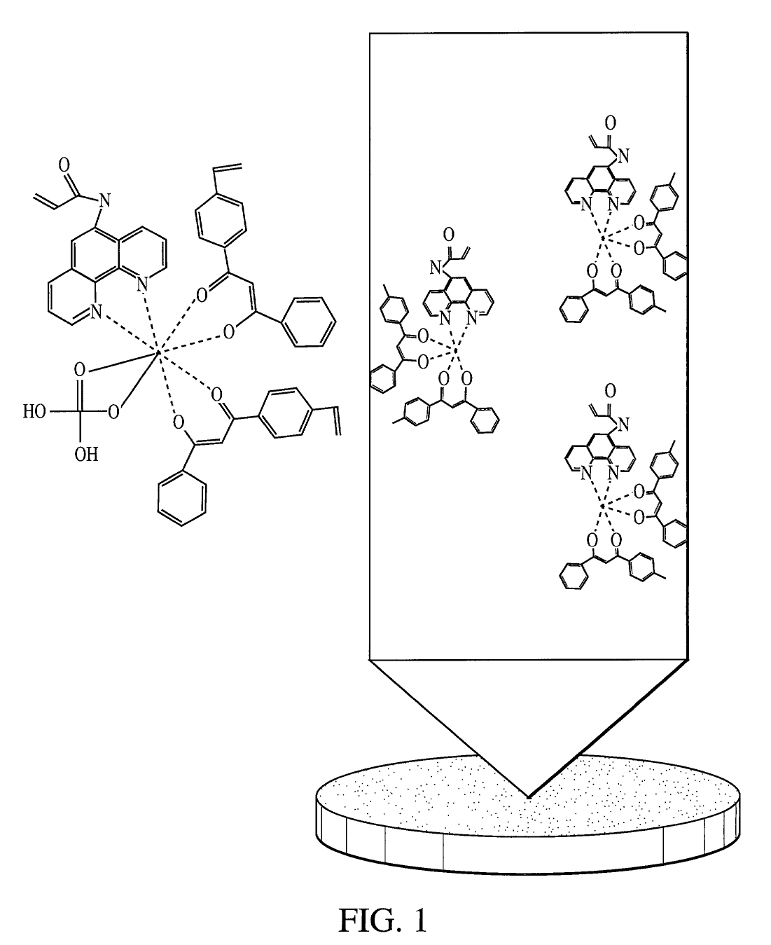

Membranes will be prepared using Lanthanum (III) (vinyldibenzoylacetonate) (acrylamidophenanthroline) biphosphate, H[La(VBZAC)2(ACPHEN)HP04] as the phosphate anion imprinting complex. Styrene will be used as the matrix-monomer and divinylbenzene will be used as the cross linking monomer. Membrane synthesis will be carried out in a screw-top vial-by dissolving the iron vinylbenzoate complex (20 to 150 mg), in a solution consisting of 400 mL of nitrophenyl octyl ether (NPOE) as a plasticizer. 22 mg of a polyester, prepared from diglycolic acid and 1,6 hexanediol, will be added to the polymerization mixture. After deaeration with dry nitrogen, 20 mg of a free radical initiator, 2,2′-azobisisobutyronitrile (AIBN) will be added. The vial will be scaled and placed in a sonicator at 60 C. The solution is sonicated until viscous, and the viscous solution will be poured into a Teflon mold. The resultant mold will be kept in a scaled container and placed in an oven at 60 C for 18 hours to complete the polymerization. The thickness of the resulting membranes is expected to be approximately 100 microns. The anion templates and the polyester will be removed using a 0.1M acetic acid solution followed by a 5% nitric acid solution. See FIG. 1.

Molecular imprinting is a process for making selective recognition sites in synthetic polymers. The process employs a target molecule as the template. The template is surrounded by molecular compliments that possess polymerizable functionalities. The template complex is typically co-polymerized with a matrix monomer and a cross-linking monomer in the presence of a suitable solvent. The cross linking monomers add rigidity to the finished polymer and the solvent provides site accessibility. Removal of the template molecules leaves behind cavities that exhibit enhanced affinity for rebinding the target molecule. Previously, we used the molecular imprinting technique to prepare a selectively permeable membrane for the removal of uranyl ion from solutions. See A. Kimaro, L. A. Kelly, and G. M. Murray, Chem. Commun., 2001, 1282-1293, which is hereby incorporated herein by reference in its entirety. By changing the formula to produce a selective binding site for nitrate anions we can make membranes selective to this nutrient species.

The polymeric membranes will be synthesized with ingredients for both selective binding and improved permeability. The selective binding site will prepared by using ferric ion imprinting. Permeability will be addressed using a polyester that associates with the metal ions. The length of the alkyl chain in the diol that was used to make the polyester controlled the spacing of association sites. The polyester will be removed from the membrane by the same acid treatment used to remove the ferric ion. Removal of the polyester from a uranyl templated membrane was detected by GC-MS of the membrane acid wash solutions. The polyester is intended to create channels, directing ion migration to the imprinted sites, thus increasing flux but maintaining selectivity. The addition of polyester to the formula had two significant results. The amount of swelling of the membrane in aqueous solutions was dramatically increased and in the absence of the polyester there was no detectable migration of ions for a previous uranyl imprinted membrane.

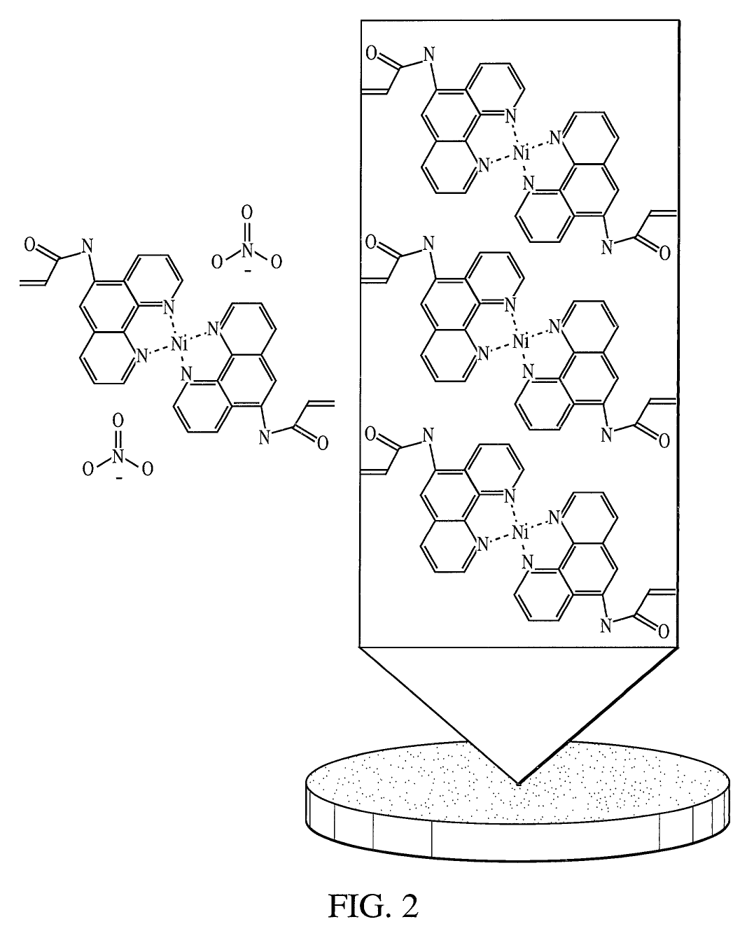

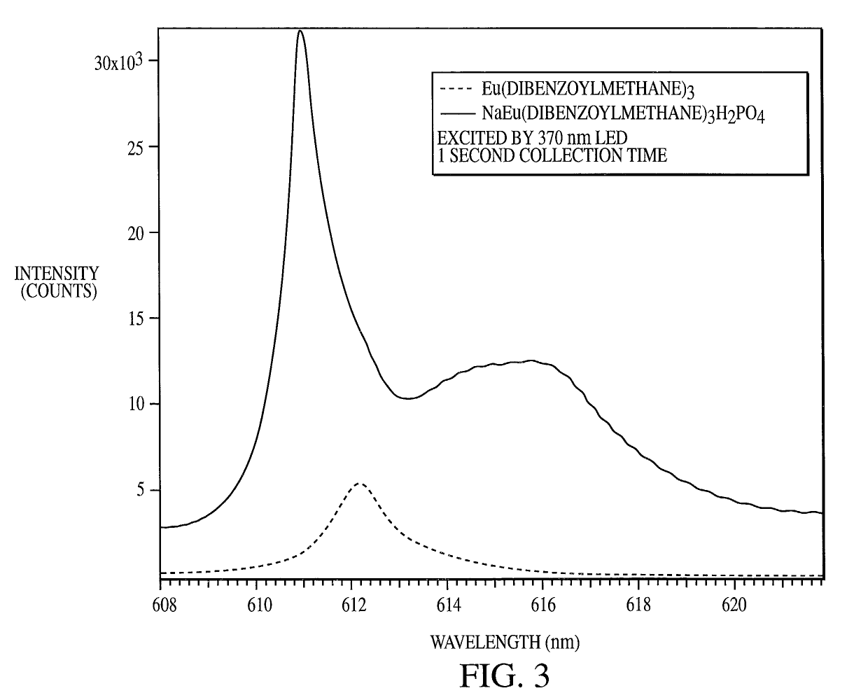

Membranes will be prepared using Nickel (II) (bis-acrylamidophenanthroline) dinitate Ni(ACPEN)2(NO3)2 as the nitrate anion imprinting complex, since this is the ingredient used in nitrate ion selective electrodes. Styrene will be used as the matrix monomer and divinylbenzene will be used as the cross linking monomer. Membrane synthesis will be carried out in a screw-top vial by dissolving the iron vinylbenzoate complex (20 to 150 mg), in solution consisting of 400 mL of nitrophenyl octyl ether (NPOE) as a plasticizer. 22 mg of a polyester, prepared from diglycolic acid and 1,6 hexanediol, will be added to the polymerization mixture. After deaeration with dry nitrogen, 20 mg of a free radical initiator, 2,2′-azobisisobutyronitrile (AIBN) will be added. The vial will be scaled and placed in a sonicator at 60 C. The solution is sonicated until viscous, and the viscous solution will be poured into a Teflon mold. The resultant mold will be kept in a sealed container and placed in an oven at 60 C for 18 hours to complete the polymerization. The thickness of the resulting membranes is expected to be approximately 100 microns. The anion templates and the polyester will be removed using a 0.1M acetic acid solution followed by a 5% perchloric acid solution. See FIG. 2. U.S. patent application Ser. No. 09/300,867, filed Apr. 28, 1999 is incorporated herein by reference in its entirety.

What is claimed is:

1. A filter for removing phosphate from a medium comprising a permeable membrane comprising a molecularly imprinted polymer having selective binding sites for phosphate anions.

2. A filter for removing nitrate from a medium comprising a permeable membrane comprising a molecularly imprinted polymer having selective binding sites for nitrate anions.
